(19) United States
(12) Patent Application Publication
(10) Pub. No.: US 2020/0051137 A1
(43) Pub. Date: Feb. 13, 2020

(54) SYSTEM, COMPUTER-READABLE MEDIA AND COMPUTER-IMPLEMENTED METHOD FOR GEO-VERIFIED REVIEWS

(71) Applicant: Mastercard International Incorporated, Purchase, NY (US)

(72) Inventors: Brian A. Williams, St. Peters, MO (US); Ping X. Chen, Chesterfield, MO (US); Richard B. Unnerstall, O'Fallon, MO (US); Christopher Eric Mullen, St. Peters, MO (US); Emily Marie Thompson, St. Peters, MO (US); Zhenni Hu, St. Charles, MO (US)

(73) Assignee: Mastercard International Incorporated, Purchase, NY (US)

(21) Appl. No.: 16/056,769

(22) Filed: Aug. 7, 2018

(51) Int. Cl. G06Q 30/02; G06F 21/31; G06F 17/30

(52) U.S. Cl. CPC G06Q 30/0282; G06F 17/30241; G06F 21/31

(57) ABSTRACT

A system, computer-readable media and computer-implemented method for geo-verification of consumer reviews. The method may be carried out by one or more processor(s) configured to execute instructions of a software application stored on the computer-readable media. The method may include receiving consumer location data and generating a first one-time code. The first one-time code and a seller location identifier may be stored in an entry of a review code database, the seller location identifier reflecting a location of a consumer corresponding to the consumer location data. A second one-time code and at least a portion of a review may be received, the at least a portion of the review including a seller location reference. The entry including the seller location identifier may be identified, the seller location identifier corresponding to the seller location reference. The first one-time code of the entry may be matched to the second one-time code. A verification message relating to the review may be generated.

### FIELD OF THE INVENTION

The present disclosure generally relates to systems, computer-readable media and computer-implemented methods for verifying reviews using geographic location data.

### BACKGROUND

People may review sellers of products based on transactions with those sellers. Where a seller and a reviewer are pre-registered on a tool that provides review functions, means exist for linking a review of the reviewer to an actual transaction with the seller. For instance, a third-party e-commerce website may have buyer and seller registration processes as well as transaction-tracking processes. Confirming that a buyer purchased a reviewed product from a seller using such processes is known.

Existing technologies restrict review verification in ways that lead to reduced consumer confidence and/or consumer choice. In an example, technological barriers to review verification lead to fewer platform(s) for consumers to select from when seeking to make a purchase and/or to increased burdens when seeking to make purchases from other platform(s).

### BRIEF SUMMARY

Embodiments of the present technology relate to systems, computer-readable media and computer-implemented methods for geo-verification of consumer reviews. Embodiments of the present technology provide an improved means for directly and/or indirectly linking a draft review to a transaction with a seller under review. According to an embodiment, the improved means may permit review submission across multiple consumer devices and/or to various third-party website(s), without the requirement for encryption and/or transmission of sensitive and/or personal data.

In a first aspect, a system for geo-verification of consumer reviews may be provided. The system may comprise a review tracking server. The review tracking server may include a transceiver element, a memory element, and a processing element which executes a software application. The software application may be configured to: receive consumer location data and generate a first one-time code; store the first one-time code and a seller location identifier in an entry of a review code database, the seller location identifier reflecting a location of a consumer corresponding to the consumer location data; receive a second one-time code and at least a portion of a review, the at least a portion of the review including a seller location reference; identify the entry including the seller location identifier, the seller location identifier corresponding to the seller location reference; match the first one-time code of the entry to the second one-time code; and generate a verification message relating to the review. The system may include additional, less, or alternate functionality, including that discussed elsewhere herein.

In another aspect, a computer-implemented method for geo-verification of consumer reviews may be provided. The computer-implemented method may include receiving consumer location data and generating a first one-time code. The first one-time code and a seller location identifier may be stored in an entry of a review code database, the seller location identifier reflecting a location of a consumer corresponding to the consumer location data. A second one-time code and at least a portion of a review may be received, the at least a portion of the review including a seller location reference. The entry including the seller location identifier may be identified, the seller location identifier corresponding to the seller location reference. The first one-time code of the entry may be matched to the second one-time code. A verification message relating to the review may be generated. The method may include additional, less, or alternate actions, including those discussed elsewhere herein.

In still another aspect, a system comprising computer-readable media for geo-verification of consumer reviews may be provided. The system may include a non-transitory computer-readable medium with a program stored thereon, wherein the program instructs a hardware processing element of a review tracking server to: receive consumer location data and generate a first one-time code; store the first one-time code and a seller location identifier in an entry of a review code database, the seller location identifier reflecting a location of a consumer corresponding to the consumer location data; receive a second one-time code and at least a portion of a review, the at least a portion of the review including a seller location reference; identify the entry including the seller location identifier, the seller location identifier corresponding to the seller location reference; match the first one-time code of the entry to the second one-time code; and generate a verification message relating to the review. The program(s) stored on the computer-readable media may instruct the processing elements to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which embodiments of a system may be utilized for geo-verification of consumer reviews;

FIG. 2 illustrates various components of an exemplary second consumer device shown in block schematic form;

FIG. 3 illustrates various components of an exemplary mobile electronic device shown in block schematic form;

FIG. 4 illustrates various components of a review tracking server shown in block schematic form;

FIG. 5 illustrates various components of an exemplary third-party review server shown in block schematic form; and

FIG. 6 illustrates at least a portion of the steps of an exemplary computer-implemented method for geo-verification of consumer reviews.

### DETAILED DESCRIPTION

The present embodiments described in this patent application and other possible embodiments may relate to systems and methods for geo-verification of consumer reviews. Embodiments of the present invention may be utilized to provide improved means for directly and/or indirectly linking a draft review to a transaction with a seller under review. According to an embodiment, the improved means may permit review submission across multiple consumer devices and/or to various third-party website(s), without the requirement for encryption and/or transmission of sensitive and/or personal data.

The present embodiments may relate to, inter alia, an application of a review tracking server that receives consumer location data and generates a first one-time code. The first one-time code and a seller location identifier may be stored in an entry of a review code database, the seller location identifier reflecting a location of a consumer corresponding to the consumer location data. A second one-time code and at least a portion of a review may be received, the at least a portion of the review including a seller location reference. The entry including the seller location identifier may be identified, the seller location identifier corresponding to the seller location reference. The first one-time code of the entry may be matched to the second one-time code. A verification message relating to the review may be generated.

One advantage of embodiments of the present invention is the ability of a consumer to submit draft reviews across multiple devices and/or to multiple different intermediate third-party devices. For instance, in an embodiment a one-time code data file (on the consumer mobile electronic device) contains no sensitive information. Event purchase history (e.g., seller location) data may be omitted, and the one-time code data file may comprise only random alphanumeric strings and/or encrypted strings of characters. The one-time code data file may therefore be relied upon for geo-verification without the need for added security. Moreover, the one-time code data file may be made accessible to multiple devices of the consumer with minimal associated security burdens. Therefore, in an example, the consumer mobile electronic device may be worn by the consumer during a transaction at a seller location, leading to generation of a one-time code. The consumer may then draft and submit a review on a second consumer device configured to access the consumer's one-time code data file (and/or may receive the one-time code via manual input at the second consumer device). In this manner, the consumer may post a geo-verified review from a different device from the one that was tracked during the transaction (and is therefore used for the verification). Still further, the consumer may post reviews to third-party sites—for example a site hosted on a third-party review server—using the one-time codes, each of which may be passed by the third-party review server to the review tracking server for verification, as described in more detail below.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled

### Exemplary System

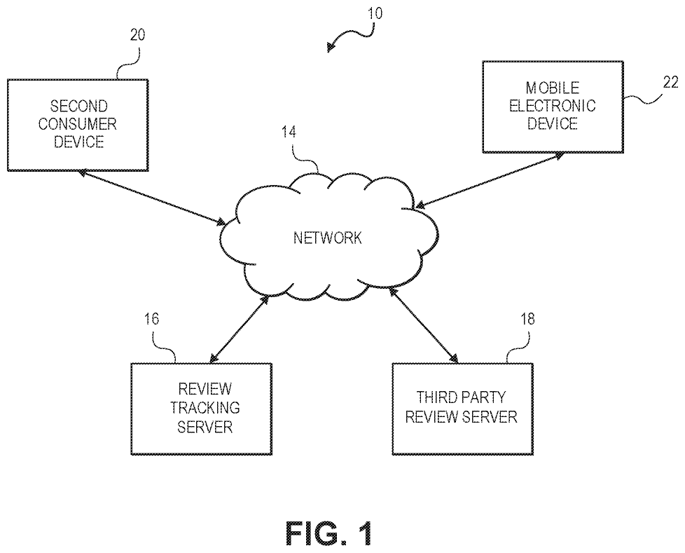

FIG. 1 depicts an exemplary environment in which embodiments of a system 10 may be utilized for geo-verification of consumer reviews. The environment may include a network 14 and computer servers 16, 18—as seen in FIGS. 1, 4 and 5—with which the system 10 interfaces to send and receive information for geo-verification of consumer reviews. The information may include geo-location data, seller location data and/or one-time codes for association with the consumer reviews.

The consumer mobile electronic device 22 may be kept near the consumer to enable transmitting location information about the consumer and carrying out other steps for geo-verification of consumer reviews, as outlined in more detail below. The consumer mobile electronic device 22 may execute geo-verification application 24. Geo-verification application 24 may include instructions for transmitting information required for generation and verification of a one-time code representing a transaction for geo-verification of a review. Operations of the application 24 may be carried out via the network 14 and/or one or more of the devices and servers 16, 18, 20. The second consumer device 20 may also or alternatively associate the one-time code with a review in an embodiment of the present invention.

The network 14 may generally allow communication between the second consumer device 20, the mobile electronic device 22 and the servers 16, 18. The network 14 may include local area networks, metro area networks, wide area networks, cloud networks, the Internet, cellular networks, plain old telephone service (POTS) networks, and the like, or combinations thereof. The network 14 may be wired, wireless, or combinations thereof and may include components such as modems, gateways, switches, routers, hubs, access points, repeaters, towers, and the like. The second consumer device 20 and/or the mobile electronic device 22 may generally connect to the network 14 wirelessly, such as radio frequency (RF) communication using wireless standards such as cellular 2G, 3G, or 4G, Institute of Electrical and Electronics Engineers (IEEE) 802.11 standards such as WiFi, IEEE 802.16 standards such as WiMAX, Bluetooth®, or combinations thereof.

Each computer server 16, 18 generally retains electronic data and may respond to requests to retrieve data as well as to store data. The computer servers 16, 18 may be embodied by application servers, database servers, file servers, gaming servers, mail servers, print servers, web servers, or the like, or combinations thereof. Furthermore, the computer servers 16, 18 may include a plurality of servers, virtual servers, or combinations thereof. The computer servers 16, 18 may also include processors, memory storage such as optical drives, hard disk drives, rack-mount drives, blade drives, and the like, and transceiver components that provide wired and/or wireless communication with the network 14.

The computer servers 16, 18 may be configured to include or execute software such as file storage applications, database applications, email or messaging applications, web server applications, or the like. The computer servers 16, 18 may apply business methods or algorithms, may utilize lookup tables or databases, or combinations thereof to receive, store and/or disseminate information relating to sellers, consumers, geo-locations, and one-time codes, according to embodiments of the present inventive concept. For example, the review tracking server 16 may periodically or continuously receive, store and/or transmit information regarding geo-location of the mobile electronic device 22. The review tracking server 16 may also respond to queries from one or more third-party review servers 18 to confirm reviewers' transaction geo-location using the one-time codes submitted with reviews.

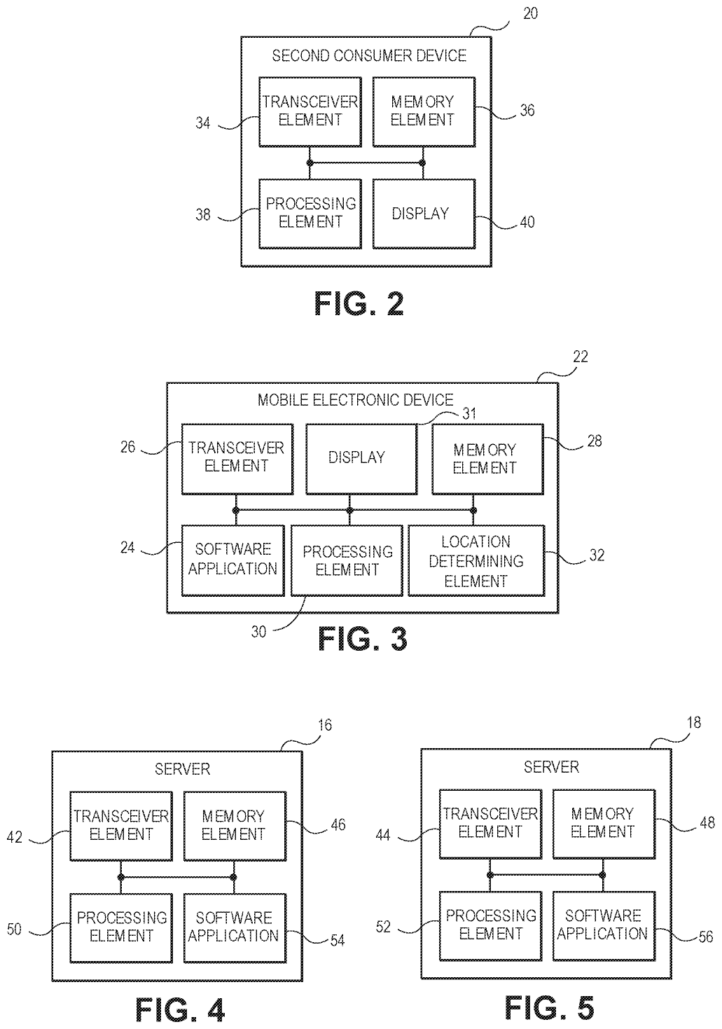

Each of the second consumer device(s) 20 and the mobile electronic device 22 may be embodied by a smart watch, a smart phone, a personal digital assistant (PDA), a tablet, a palmtop or laptop computer, or another mobile device. In an embodiment, the mobile electronic device 22 may include a transceiver element 26, a memory element 28, a processing element 30, a display 31 and a location determining element 32, along with geo-verification application 24, as seen in FIG. 3. The second consumer device(s) 20 may each include a transceiver element 34, a memory element 36, a processing element 38, and a display 40, as seen in FIG. 2. The servers 16, 18 may respectively include transceiver elements 42, 44, memory elements 46, 48, processing elements 50, 52, and software applications 54, 56, as seen in FIGS. 4-5.

The transceiver elements 26, 34, 42, 44 may each respectively allow wireless and/or wired communication generally with external systems or devices. Each of the transceiver elements 26, 34, 42, 44 may include signal or data transmitting and receiving circuits, such as antennas, amplifiers, filters, mixers, oscillators, digital signal processors (DSPs), and the like. The transceiver elements 26, 34, 42, 44 may establish communication wirelessly by utilizing RF signals and/or data that comply with communication standards such as cellular 2G, 3G, or 4G, WiFi, WiMAX, Bluetooth®, BLE, or combinations thereof. The transceiver elements 26, 34, 42, 44 may respectively be in communication with the processing elements 30, 38, 50, 52 and the memory elements 28, 36, 46, 48.

Each of the memory elements 28, 36, 46, 48 may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, one or more of the memory elements 28, 36, 46, 48 may be embedded in, or packaged in the same package as, respective ones of the processing elements 30, 38, 50, 52. Each memory element 28, 36, 46, 48 may include, or may constitute, a “computer-readable medium.” The memory elements 28, 36, 46, 48 may store the instructions, code, code segments, software, firmware, programs, applications, apps, services, daemons, or the like that are executed by respective ones of the processing elements 30, 38, 50, 52.

Each of the processing elements 30, 38, 50, 52 may include processors, microprocessors (single-core and multi-core), microcontrollers, DSPs, field-programmable gate arrays (FPGAs), analog and/or digital application-specific integrated circuits (ASICs), or the like, or combinations thereof. The processing elements 30, 38, 50, 52 may generally execute, process, or run instructions, code, code segments, software, firmware, programs, applications, apps, processes, services, daemons, or the like. The processing elements 30, 38, 50, 52 may also include hardware components such as finite-state machines, sequential and combinational logic, and other electronic circuits that can perform the functions necessary for the operation of the current invention. Each of the processing elements 30, 38, 50, 52 may be in communication with the other electronic components of its respective device through serial or parallel links that include address busses, data busses, control lines, and the like.

The location determining element(s) 32 generally determine a current geolocation of the mobile electronic device 22 and may receive and process radio frequency (RF) signals from a global navigation satellite system (GNSS) such as the global positioning system (GPS) primarily used in the United States, the GLONASS system primarily used in regions formerly part of the Soviet Union, or the Galileo system primarily used in Europe. Each location determining element 32 may accompany or include an antenna to assist in receiving the satellite signals. The antenna may be a patch antenna, a linear antenna, or any other type of antenna that may be used with location or navigation devices. Each location determining element 32 may include satellite navigation receivers, processors, controllers, other computing devices, or combinations thereof, and memory. Each location determining element 32 may process a signal, referred to herein as a “location signal,” from one or more satellites that includes data from which geographic information such as the current geolocation is derived. The current geolocation may include coordinates, such as the latitude and longitude, of the current location of the mobile electronic device 22. The location determining element(s) 32 may communicate the current geolocation to the processing element 30, memory element 28, or both.

Although embodiments of the location determining element(s) 32 may include a satellite navigation receiver, it will be appreciated that other location-determining technology may be used. For example, cellular towers or any customized transmitting radio frequency towers may be used instead of satellites to determine the location of the corresponding electronic device(s) by receiving data from at least three transmitting locations and then performing basic triangulation calculations to determine the relative position of the device with respect to the transmitting locations. With such a configuration, any standard geometric triangulation algorithm may be used to determine the location of the mobile electronic device(s) 22. Each location determining element 32 may also include or be coupled with a pedometer, accelerometer, compass, or other dead-reckoning components which allow it to determine the location of the corresponding electronic device. Each location determining element 32 may determine the current geographic location through a communications network, such as by using Assisted GPS (A-GPS), or from another electronic device. The location determining element(s) 32 may even receive location data directly from a consumer.

The displays 31, 40 may each comprise a user interface of the corresponding electronic device 22, 20. The displays 31, 40 may each include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, or the like, or combinations thereof. The displays 31, 40 may possess a square or a rectangular aspect ratio and may be viewed in either a landscape or a portrait mode. In various embodiments, the displays 31, 40 may also include a touch screen occupying the entire screen or a portion thereof so that the display functions as part of a user interface. The touch screen may allow the consumer to interact with the corresponding electronic device 22, 20 by physically touching, swiping, or gesturing on areas of the screen.

In an embodiment, the geo-verification application 24 may be configured to directly or indirectly (e.g., via the location determining element 32 and/or a digital mapping application running on the device 22) determine the geolocation of the device 22. Such location-tracking may be periodic and/or, preferably, substantially continuous. In an embodiment, geolocation(s) of the device 22 previously or currently and/or expected geolocation(s) in the future (e.g., where a digital mapping application provides intended travel route data) are determined by the device 22.

In an exemplary embodiment, a consumer may carry the mobile electronic device 22 within a geo-fence of a seller location. For instance, the seller location may be a restaurant. The geo-verification application 24 of the mobile electronic device 22 may transmit location data generated by the location determining element 32 to the review tracking server 16. The review tracking server 16 may reply with a one-time code. The review tracking server 16 may store the one-time code in a review code database with a seller location identifier referencing the restaurant. The seller location identifier may be obtained by comparing the location data against a seller location database. The review tracking server 16 may also store a milestone timestamp associated with a time of departure by the consumer from the area of the geo-fence.

The mobile electronic device 22 may receive the one-time code and store same in a consumer data file. The consumer data file may be maintained by a cloud computing service (not shown) under an account linked to the consumer. Several days later, the consumer may draft a review on the second consumer device 20. The consumer may also direct the second consumer device 20 and/or the third-party review server 18 to attempt geo-verification of the draft review using the consumer data file. The second consumer device 20 and/or the third-party review server 18 may access the consumer's data file via the cloud computing service, and may transmit the consumer's data file and the draft review to the review tracking server 16 for geo-verification.

The review tracking server 16 may parse the draft review to extract a seller location reference for use in a search query of the review code database. The review tracking server 16 may identify all one-time code entries in the review code database that respectively match entries in the consumer's data file. If the one-time code entry(ies) contain at least one match for the seller location reference in the seller location identifier field(s), one or more such such seller-matched entries also contain matching one-time codes, and the milestone timestamp does not indicate that the one-time code(s) are expired, the review tracking server 16 may issue a verification message to the second consumer device 20 or the third-party review server 18 indicating that the draft review is geo-verified. The second consumer device 20 or the third-party review server 18 may post the draft review and/or amend the already-posted review to indicate completion of the geo-verification process. If a match was not found in the review code database and/or if the milestone timestamp indicates that a matched one-time code was expired, the review tracking server 16 may issue a validation error.

### Exemplary Computer-Implemented Method

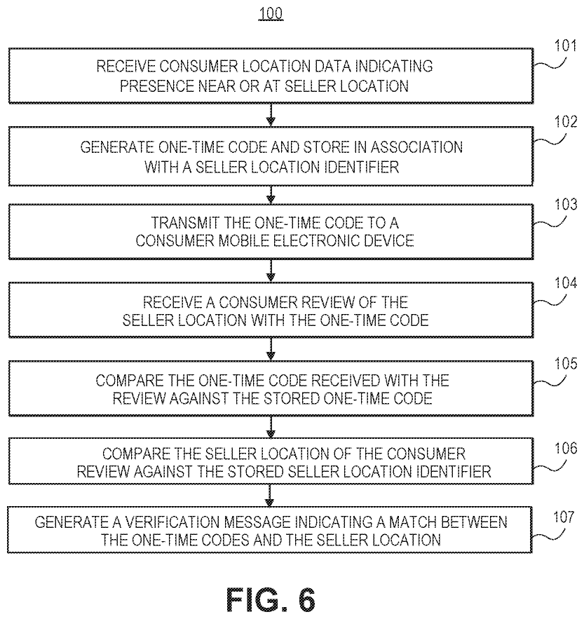

FIG. 6 depicts a listing of steps of an exemplary computer-implemented method 100 for geo-verification of consumer reviews. The steps may be performed in the order shown in FIG. 6, or they may be performed in a different order. Furthermore, some steps may be performed concurrently as opposed to sequentially. In addition, some steps may be optional.

The computer-implemented method 100 is described below, for ease of reference, as being executed by exemplary devices and components introduced with the embodiments illustrated in FIGS. 1-5. For example, the steps of the computer-implemented method 100 may be performed by the (consumer) mobile device 22, the second consumer device 20, the network 14, and one or both of the servers 16, 18 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. For example, the steps performed by the servers 16, 18 may be performed in whole or in part by one or both of (user) mobile electronic device(s) 22, 20 without departing from the spirit of the present invention. For another example, the steps performed by the mobile electronic (or consumer) device(s) 22 may be performed in part by one or both of the servers 16, 18 without departing from the spirit of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 101, location data indicating a consumer's presence near or at a seller location may be received. In an embodiment, a third-party software application—such as a social networking application—may be configured to receive location data from a location determining element of the consumer's mobile device to determine that it is within a geo-fence of the seller. In another embodiment, the consumer's mobile device may transmit data generated by the location determining element to the review tracking server for comparison against a geo-fence of the seller, as described in more detail below. In still another embodiment, a mapping application executing on the consumer's mobile device may transmit data generated by the location determining element to the review tracking server for comparison against a geo-fence of the seller.

Location data may be continuously or intermittently generated and/or transmitted by the consumer mobile electronic device for use in determining a location of the device. More particularly, the device may generate location data continuously, according to a pre-determined schedule and/or intermittently in response to one or more triggers. Triggers may be environmental and/or based on consumer actions, such as where the consumer presses a button on the display of the consumer mobile electronic device requesting a one-time code, launches a seller app and/or a mapping application or the like. It is foreseen that various triggers and/or schedules or settings may govern location data generation without departing from the spirit of the present invention.

The location data may be transmitted to and received by the review tracking server. The location data received by the review tracking server may comprise a timestamped data entry indicating when the consumer was confirmed at a seller location according to a trusted third-party application (such as a social media app configured to utilize location determining element data and seller location data to “check-in” the consumer). The location data may also or alternatively comprise latitude and longitude coordinates or the like (as described in more detail above) for comparison against seller location data by the review tracking server. For instance, the review tracking server may compare the location data for the mobile electronic device against a seller location database.

In an embodiment, the seller location database may contain data regarding the boundaries of properties owned respectively by sellers and/or regarding geo-fences associated with the properties of the sellers. Each geo-fence of the seller may be determined automatically according to system settings and/or may be determined by the seller and/or a seller representative. Where determined according to system settings, the same geo-fence may be applied to each seller location. For example, the default geo-fence of each seller may comprise a circle drawn with five hundred (500) feet of removal from the smallest circle that can be drawn to encompass the seller's property boundaries. For another example, the default geo-fence may be co-extensive with the seller's property boundaries. Sellers may also be separated into categories based on products or activities being offered—for instance based on metadata about the sellers available in the database (e.g., merchant code categorization utilized by a payment network)—with category membership at least in part determining the contours and/or extent of each geo-fence. Where sellers are permitted some freedom in defining the shape and/or extent of their respective geo-fences, pre-determined parameters may be applied to prevent misuse and/or inaccuracies. For instance, minimum values may be set to ensure sellers are not too restrictive in who is permitted to review their products or activities and/or maximum values may be set to reduce false positives in confirming consumer transactions. In another embodiment, the seller location data may be provided to a mapping software application or the like (e.g., that provided under the mark GOOGLE® MAPS or the like)—which may be made available via query to an application programming interface in an embodiment—to determine a seller location and/or a seller location identifier.

One of ordinary skill will appreciate that location data may be alternatively comprised within the scope of the present invention. For example, sensors (e.g., at trusted sources such as automated teller machines or the like) may capture biometric data identifying the consumer at a seller location, and may transmit resulting timestamped biometric, personal and/or location data to the review tracking server. For another example, the consumer may make a payment for goods or services using an authenticated payment method (e.g., using MASTERPASS® digital wallet services offered by Mastercard International Incorporated Corporation) at a seller location, and the fact of that transaction (including personal data) and the seller location may be transmitted as location data to the review tracking server. It is foreseen that other means of confirming a consumer's presence at a seller location may be employed without departing from the spirit of the present invention.

Referring to step 102, a first one-time code may be generated and stored in association with a seller location identifier. The seller location identifier may correspond to the seller location geo-fence that the consumer was indicated as being within based on analysis of the location data transmitted to the review tracking server in step 101. The seller location identifier may be any combination of characters representing a unique seller geolocation. For instance, the seller location identifier may comprise a store number, a seller name, a seller location address, a seller trademark, and so on and so forth. One of ordinary skill will appreciate that there are a variety of ways to identify a unique seller geolocation within the scope of the present invention. In another embodiment, the seller location identifier may comprise any combination of characters uniquely identifying a seller (e.g., by brand name), without identifying which of multiple seller locations was actually visited by the consumer, without departing from the spirit of the present invention. For instance, a purchase made at a franchise location may simply be stored under the broader franchise, enabling a review of the franchise based on a purchase at a single location. One of ordinary skill will appreciate that various methods for grouping discrete seller locations may be employed within the scope of the present invention.

The one-time code and the seller location identifier may be stored in a review code database. Each one-time code may comprise a grouping of characters unique among a plurality of one-time codes stored within the review code database. In an example, the one-time code may comprise the output of a sequential number generator and may be stored in a first field of a data entry, the data entry also including the seller location identifier in a second field. For another example, a random or pseudo-random number generator may be used, along with a code log file tracking all previously-used random numbers, wherein each random number is checked against the code log file before being saved to the review code database to ensure uniqueness. It is foreseen that various other unique identifiers may be generated for use as one-time codes without departing from the spirit of the present invention.

In an embodiment, the one-time code and the seller location identifier may also be saved with milestone timestamp data indicating a milestone event. The milestone event may be a time of departure (if available from the location data received in step 101) of the consumer from the seller location, of issuance of the one-time code to the consumer (as described below), of consummation of a transaction, or of another milestone event. The milestone timestamp data may be used to sunset or expire the one-time code for use in verifying seller reviews. More particularly, the review tracking server may be configured to evaluate milestone timestamp data of an entry corresponding to an attempted review to determine whether the entry has expired as of the time of attempted review (rendering the one-time code of the entry ineffective for geo-verification of the attempted review). For instance, the consumer may be prevented from reviewing a seller's goods more than thirty (30) days after the consumer's last visit to the seller's location. The milestone timestamp data may indicate a date of last visit to the seller's location, permitting the review tracking server to decline validation of reviews submitted more than thirty (30) days after the date of last visit by the consumer. The valid duration of a one-time code may be set by each seller according to preference(s). System administrators may also set boundaries on permissible values that may be selected for one-time code duration by sellers.

In an embodiment, the one-time code and the seller location may also be saved with transaction data obtained from a payment network, issuer and/or point-of-sale device, for example. The transaction data may indicate the category of goods/services purchased and/or may identify the specific goods/services purchased in conjunction with generation of the first one-time code and/or during the consumer's visit to the seller location associated with generation of the first one-time code. In another embodiment, personal data regarding the consumer may also or alternatively be saved with the one-time code and the seller location. Such personal data may be transmitted with the location data by the consumer mobile electronic device, and may comprise the consumer's name, e-mail address, (seller) customer number, mobile phone number, or the like. The personal data may be encrypted in an embodiment of the present invention. The review tracking server may utilize such transaction and/or personal data as additional data points to validate reviews by the consumer, as described in more detail below.

Referring to step 103, the one-time code may be transmitted to the consumer mobile electronic device, e.g., by the review tracking server. The consumer mobile electronic device may store the one-time code in a one-time code log file or other data file for review verification. It is also foreseen that the data file may be stored at another device—such as in a cloud computing database under an account maintained by the consumer—without departing from the spirit of the present invention. One of ordinary skill will appreciate that the data file may be accessible to one or more software applications across one or more computing devices—including a second consumer device—within the scope of the present invention.

In an embodiment, the seller location may also be transmitted by the review tracking server, with the one-time code, for storage in the data file of the consumer mobile electronic device. Alternatively or in addition, the consumer mobile electronic device may be configured to independently record one or more nearby seller locations in connection with receipt of each one-time code from the review tracking server. The latter approach may improve validation processes according to embodiments of the present invention through introduction of an independent verification mechanism. In each case, however, the consumer's one-time code data file may be maintained to include one or more seller locations identified with each one-time code received.

Referring to step 104, the one-time code may be received at the review tracking server along with a reference to and/or all or part of a consumer review. The one-time code (and/or personal data) may be decrypted, as needed, by the review tracking server. The reference to and/or all or part of a consumer review may comprise any information tending to identify a seller and/or seller location that is the subject of the review of the consumer. In an embodiment, the one-time code and seller review/reference will also be accompanied by personal data such as identifying information for the consumer. In another embodiment, the one-time code will include information identifying the consumer (as described in more detail above). In yet still another embodiment, the reference to and/or all or part of a consumer review may comprise information describing one or more products/services that are the subject of the review. For instance, the information transmitted in response to an attempted review submission by the consumer may include: a unique, pseudo random one-time code; a seller location from the consumer data file generated via the consumer mobile electronic device's location determining element in connection with initial receipt of the one-time code; the reviewing consumer's e-mail address; a seller location name extracted from the review by a regex expression executed by the consumer mobile application device; and, a product name extracted from the review by a regex expression executed by the consumer mobile application device.

It is foreseen that information may be parsed from the review by a variety of parsing tools/expressions other than or in addition to regex expressions without departing from the spirit of the present invention. It is also foreseen that one or more of the computing devices may use automated optical character recognition to analyze any photographs posted with the consumer review(s), for example to help determine the seller, seller location and/or seller location identifier, without departing from the spirit of the present invention.

In an embodiment, the data file containing the reviewing consumer's one-time codes may be transmitted in its entirety to the review tracking server. In another embodiment, only one-time code entries matching the seller/seller location may be sent from the consumer's data file to the review tracking server. In still another embodiment, only the specific one-time code entries for the transaction that is the subject of the consumer review may be transmitted to the review tracking server.

The proportion of the consumer's one-time code data file transmitted to the review tracking server may be determined, at least in part, by the metadata and/or transactional data regarding the consumer review accessible to the device(s) at the time of gathering the one-time code for transmission to the review tracking server. The proportion of the consumer's one-time code data file transmitted to the review tracking server may also be determined, at least in part, by the degree of active oversight the consumer exercises in selecting the correct one-time code for submission to the review tracking server with the proposed review.

More particularly, one of the consumer devices and/or the third-party review server may transmit the draft consumer review along with the one-time code to the review tracking server. The one-time code may be accessed from the consumer's code data file for inclusion in the transmission. If the device collecting the one-time code for transmission does not also have data regarding and/or a user selection of the seller location and/or good/service under review, the entire code data file may be transmitted to the review tracking server.

However, if the collecting device has additional details about the seller and/or transaction under review at the time of collection, fewer entries of the data file may be transmitted with the review. For instance, in some embodiments the data file may include seller location data and the collecting device may have data regarding the seller location under review at the time of collection. The device collecting the one-time code from the data file for transmission with a draft consumer review may be able to sort and/or search the consumer's one-time code data file for entries matching the seller location under review. The device collecting the one-time code may therefore only transmit one-time codes having matching seller locations in the data file. Moreover, if the collecting device has data regarding specific timeframes (e.g., via timestamp data), transactions, and/or product/services which are under review, the search through the one-time code data file may be further narrowed according to one or more of these pieces of data (assuming complementary data is available in the consumer data file). It is also foreseen that the user may select and manage one-time codes manually—for example by scrolling through the one-time code data file for a one-time code corresponding to a time of visiting the seller under review—without departing from the spirit of the present invention. Moreover, the consumer may input labels for one-time codes upon receipt from the review tracking server (e.g., by identifying the seller location associated with the one-time code), permitting the consumer to manually select the one-time code for association with a review drafted at a later time.

One advantage of embodiments of the present invention is the ability of a consumer to submit draft reviews across multiple devices and/or to multiple different intermediate third-party devices. For instance, in an embodiment a one-time code data file contains no sensitive information. Event purchase history (e.g., seller location) data may be omitted, and the one-time code data file may comprise only random alphanumeric strings and/or encrypted strings of characters. The one-time code data file may therefore be transmitted without the need for added security. Moreover, the one-time code data file may be made accessible to multiple devices of the consumer with minimal associated security burdens. Therefore, in an example, the consumer mobile electronic device may be worn by the consumer during a transaction at a seller location, leading to generation of a one-time code. The consumer may then draft and submit a review on a second consumer device linked to the consumer's one-time code data file (and/or may receive the one-time code via manual input at the second consumer device). In this manner, the consumer may post a geo-verified review from a different device from the one that was tracked during the transaction (and is therefore used to for the verification). Still further, the consumer may post reviews to third-party sites—for example a site hosted on a third-party review server—using the one-time codes, each of which may be passed by the third-party review server to the review tracking server for verification, as described in more detail below.

One of ordinary skill will recognize that device(s), if any, in the transmission chain between the review tracking server and the device participating in review generation may parse or otherwise analyze the review before passing the one-time code further along toward the review tracking server. One of ordinary skill will also appreciate that such devices may cull the one-time code entries from the data file according to such information gleaned about the draft review (in the manner of the collecting device described above) within the scope of the present invention.

For instance, the consumer may provide user input defining a review via a user interface and/or display of the second consumer device. The second consumer device may transmit the draft review along with the entire one-time code data file of the consumer to the third-party review server. The third-party review server may parse the review to determine a seller, seller location and/or seller location name (each, a “seller location reference”). The third-party review server may then match the determined seller location reference against the entries of the one-time code data file. The third-party review server may then only pass the gleaned seller location reference and the matching one-time code entry(ies) to the review tracking server for verification (as opposed to passing the entire review and entire one-time code data file along). Alternatively—for example where the data file does not include seller location data sufficient to support the matching step described immediately above—the review tracking server may simply parse the review to determine a seller location reference and transmit same (with or without the entire review) with the entire one-time code data file to the review tracking server. In still another embodiment, the review tracking server may perform the parsing operations to determine the seller location reference under review.

It should also be noted that multiple seller location references may be gleaned from parsing a review. The review tracking server may verify such a review by ensuring that each seller location reference gleaned from the review is matched to a separate one-time code entry in the review code database according to the description below. Where at least one of the seller location references does not have a match in the review code database, the review tracking server may issue a validation error and/or request additional information before validating the review (for instance, by requesting that the unmatched reference be removed from the review).

Referring to step 105, the one-time code received with at least a portion of the consumer review may be compared against the review code database. The review code database may be maintained, and the comparison may be performed, by the review tracking server. The matching one-time code data entry may be identified using a lookup function taking as its argument the one-time code received in connection with the at least a portion of the consumer review. It is foreseen that various matching and/or lookup functions may be used to retrieve matches within the review code database without departing from the spirit of the present invention. Where more than one one-time code is received in connection with the draft review, multiple matching entries in the review code database may be found. It is also possible that in certain cases there will be no matching entry in the review code database, which may prompt the review tracking server to transmit a validation error to the requesting device (e.g., the third-party review server).

Referring to step 106, the consumer review, or a portion thereof, may be compared against the matched data entries of the review code database. For instance, the consumer may have selected, or one or both of the third-party review server and the review tracking server may have parsed the review to determine, a seller location reference. The seller location reference may be matched against the seller location identifiers stored in the review code database. One or more matching assistance software applications—such as a semantic matching operator or the like—may be used to assist in the matching process (and reduce false negatives) according to known technologies. In an embodiment in which seller location identifiers are stored in the review code database according to a pre-defined taxonomy—such as where seller locations are organized according to franchise(s) and/or entities, are represented under a number system, or are otherwise organized—the seller location reference may similarly be filtered through the taxonomy as part of the matching step 106.

It should be noted here that the lookup and matching functions described above may occur in varying orders and/or simultaneously without departing from the spirit of the present invention. For instance, all entries in the review code database having seller location identifiers matching the seller location reference may be identified initially, and one-time codes received with the seller location reference may be compared against the matched entries subsequently. Alternatively or in addition, the matching and/or comparison steps may be performed simultaneously. Comparison of additional data points (e.g., transactional and/or personal data, described in more detail below) may also occur in any order—whether taken independently and/or with respect to one-time code and/or seller location identifier comparisons—within the scope of the present invention.

It should be further noted that, while a seller location reference is preferably included by the user within and/or in conjunction with a review, it is foreseen that a review may lack a seller location reference without departing from the spirit of the present invention. In such an embodiment, the one-time code provided with the review may be compared against the one-time codes of the review code database. One of ordinary skill will appreciate that the entry of the review code database that contains the matching one-time code may also contain a seller location identifier, and that the review tracking server may automatically add to and/or append the review to reflect the seller identified by the seller location identifier within the scope of the present invention.

Referring to step 107, a verification message may be generated in cases where a match is found between the one-time code and seller location reference on the one hand, and the one-time code and seller location identifier stored in the review code database on the other hand. In some embodiments, additional data points—such as transaction data and/or personal data—may also be available for matching. For example, first personal data (e.g., e-mail address, telephone number, customer account number, etc.) may be associated with the one-time code entry within the review code database, identifying the consumer that made a visit to the seller location corresponding to the seller location identifier. Second personal data identifying a reviewer may be received with the draft review information and may be compared against the first personal data (in addition to the one-time code/seller information comparison described above) to confirm identity of the reviewer. Where the first personal data and the second personal data do not match, the review tracking server may issue a validation error and/or request additional information in order to verify the consumer using the one-time code system. For another example, the draft review may be determined (e.g., from parsing operations outlined above) to contain only a reference to a first good, whereas the matching one-time code entry of the review code database may include a data field indicating that a transaction corresponding to generation of the one-time code was a purchase of a second good. The review tracking server may then issue a validation error and/or request additional information in order to verify the consumer using the one-time code system. Still further, milestone timestamp data may also or alternatively indicate that the matched one-time code entry has expired, triggering issuance of a validation error.

Where a verification message is received at a server hosting a website to which the draft review has been submitted, the server (e.g., the third-party review server) may proceed with posting the review and/or a visual indicator adjacent the review noting that geo-verification has been completed.

The method 100 may include additional, less, or alternate actions, including those discussed elsewhere herein such as in the section entitled “Exemplary System,” and/or may be implemented via a computer system, communication network, one or more processors or servers, and/or computer-executable instructions stored on non-transitory storage media or computer readable medium.

### Exemplary Implementation

In an exemplary embodiment, a consumer may carry a mobile electronic device within a geo-fence of a seller location. For instance, the seller location may be a restaurant. The mobile electronic device may transmit location data generated by a location determining element of the mobile electronic device to a review tracking server. The review tracking server may reply with a one-time code. The review tracking server may store the one-time code in a review code database with a seller location identifier referencing the restaurant. The seller location identifier may be obtained by comparing the location data against a seller location database. For example, the one-time code may read “0124795563” and the seller location identifier may comprise “Pappy's Waffle Restaurant.” The review tracking server may also store a milestone timestamp associated with a time of departure by the consumer from the area of the geo-fence.

The mobile electronic device may receive the one-time code and store same in a consumer data file. The consumer data file may be maintained by a cloud computing service under an account linked to the consumer. Several days later, the consumer may draft a review on a second consumer device (e.g., a desktop computer). The review may comprise the following: “Pappy's waffles come out cold and bland! Do not recommend!” The consumer may also direct the second consumer device and/or a third-party review server to attempt geo-verification of the draft review using the consumer data file. The second consumer device and/or the third-party review server may access the consumer's data file via the cloud computing service, and may transmit the consumer's data file and the draft review to the review tracking server for geo-verification.

The review tracking server may parse the draft review to extract “pappy's (waffles)” for use in a search query of the review code database. The review tracking server may first identify all one-time code entries in the review code database that respectively match entries in the consumer's data file. Within the matched data entries, “Pappy's Waffle Restaurant” may be determined to be sufficiently like “pappy's (waffles)” to constitute a match, though this will depend on the thresholds set in the matching and/or lookup functions and/or algorithms.

If the one-time code entry containing the “Pappy's Waffle Restaurant” seller location identifier also contains the same one-time code (i.e., “0124795563”) as one of the codes of the consumer data file, and the milestone timestamp does not indicate that the one-time code is expired, the review tracking server may issue a verification message to the second consumer device and/or the third-party review server indicating that the draft review is geo-verified. The second consumer device or the third-party review server may post the draft review and/or amend the already-posted review to indicate completion of the geo-verification process. If a match was not found in the review code database and/or if the milestone timestamp indicates that a matched one-time code was expired, the review tracking server may issue a validation error.

The method outlined above may include additional, less, or alternate actions, including those discussed elsewhere herein such as in the sections entitled “Exemplary System” and/or “Exemplary Computer-Implemented Method” and/or may be implemented via a computer system, communication network, one or more processors or servers, and/or computer-executable instructions stored on non-transitory storage media or computer readable medium.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for geo-verification of consumer reviews, the computer-implemented method comprising:
receiving consumer location data;
generating a first one-time code;
storing the first one-time code and a seller location identifier in an entry of a review code database, the seller location identifier reflecting a location of a consumer corresponding to the consumer location data;
receiving a second one-time code and at least a portion of a review, the at least a portion of the review including a seller location reference;
identifying the entry having the seller location identifier, the seller location identifier corresponding to the seller location reference;
matching the first one-time code of the entry to the second one-time code; and
generating a verification message relating to the review.

2. The computer-implemented method of claim 1, wherein the consumer location data comprises latitude and longitude data generated by a location determining element of a consumer mobile electronic device.

3. The computer-implemented method of claim 2, further comprising determining the seller location identifier at least in part by querying a seller location database using the consumer location data.

4. The computer-implemented method of claim 3, wherein the seller location identifier is determined at least in part by determining that the consumer location data corresponds to a location within a geo-fence defined within the seller location database.

5. The computer-implemented method of claim 3, wherein the seller location database comprises a mapping software application queried via an application program interface.

6. The computer-implemented method of claim 1, wherein the consumer location data comprises the seller location identifier, the seller location identifier being provided by a third-party software application.

7. The computer-implemented method of claim 1, further comprising storing milestone timestamp data with the entry.

8. The computer-implemented method of claim 7, further comprising evaluating, prior to generating the verification message, the milestone timestamp data to determine that the first one-time code has not expired.

9. The computer-implemented method of claim 1, further comprising parsing the review to generate the seller location reference.

10. The computer-implemented method of claim 1, further comprising storing transaction data indicating a purchase in the entry, the transaction data relating to a transaction occurring within a timeframe in which the first one-time code is generated.

11. The computer-implemented method of claim 10, further comprising parsing the review to identify a good or service.

12. The computer-implemented method of claim 11, further comprising comparing, prior to generating the verification message, the identified good or service against the transaction data to determine a match.

13. The computer-implemented method of claim 1, further comprising storing personal data regarding the consumer in the entry.

14. The computer-implemented method of claim 13, further comprising receiving personal data regarding a reviewer in conjunction with receiving the second one-time code.

15. The computer-implemented method of claim 14, further comprising performing identity confirmation at least in part by comparing, prior to generating the verification message, the personal data regarding the consumer to the personal data regarding the reviewer.

16. The computer-implemented method of claim 1, wherein the location data corresponds to a trigger.

17. The computer-implemented method of claim 16, wherein the trigger comprises user input at a consumer mobile electronic device comprising a request for the first one-time code.

18. The computer-implemented method of claim 16, wherein the trigger comprises user input at a consumer mobile electronic device launching an app.

19. The computer-implemented method of claim 1, wherein the location data comprises transaction data corresponding to a transaction conducted via an authenticated payment method.

20. The computer-implemented method of claim 1, wherein the location data is received in response to confirmation of biometric data about the consumer generated by a sensor.
